(19) United States
(12) Patent Application Publication
(10) Pub. No.: US 2020/0003891 A1
(43) Pub. Date: Jan. 2, 2020

(54) METHOD AND APPARATUS FOR DETERMINING A POSITION OF A TERMINAL

(71) Applicant: ALIBABA GROUP HOLDING LIMITED, George Town (KY)

(72) Inventor: Zhen TAO, Hangzhou (CN)

(73) Assignee: ALIBABA GROUP HOLDING LIMITED

(21) Appl. No.: 16/453,977

(22) Filed: Jun. 26, 2019

(30) Foreign Application Priority Data
Jun. 29, 2018 (CN) 201810712024.8

(51) Int. Cl. G01S 13/87; G01S 13/76

(52) U.S. Cl. CPC G01S 13/878; H04W 64/00; G01S 13/76

(57) ABSTRACT

The present application discloses methods and apparatuses for determining a position of a terminal. The method includes: acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame; and determining location information of the terminal according to the first transceiving moment information.

### CROSS REFERENCE TO RELATED APPLICATION

The disclosure claims the benefits of priority to Chinese application number 201810712024.8, filed Jun. 29, 2018, which is incorporated herein by reference in its entirety.

### BACKGROUND

The Internet of Things (IoT) technology is the third information technology revolution after the computer and the Internet and has advantages of real-time performance and interactivity. The IoT technology has been widely used in fields, such as urban management, digital home, positioning and navigation, logistics management, and security system. Long Range Radio (LoRa) is an ultra-long-distance transmission scheme based on the spread-spectrum technology in the Internet of Things, and is featured with a long transmission distance, low power consumption, multiple nodes, and a low cost.

Positioning is an important application of LoRa networks. Existing positioning schemes include Time of Arrival (TOA)-based positioning schemes and Time Difference of Arrival (TDOA)-based positioning schemes.

During the TOA-based positioning, a terminal and a plurality of base stations can respectively perform wireless ranging. During each time of ranging, a base station and the terminal can transceive request radio frames and acknowledgment radio frames for ranging, and then location information of the terminal can be determined according to time points of the transceiving of the frames using a TOA positioning algorithm. To perform a three-dimensional positioning, the terminal has to perform ranging with at least four base stations in sequence. Though this TOA-based positioning has a high ranging precision, it leads to unduly high wireless transmission power consumption. Moreover, errors can be caused when mobile terminals are positioned using this wireless ranging.

In TDOA-based positioning, a terminal broadcasts a radio frame, and the moment at which each base station receives the radio frame varies with the distance between the base station and the terminal. Location information of the terminal can be determined according to transceiving moments and the TDOA positioning algorithm. Due to the error of time synchronization between base stations, the TDOA-based positioning has low precision and thus is difficult to rely on.

### SUMMARY OF THE DISCLOSURE

In view of the above problem, embodiments of the present application provide a method for positioning a terminal and a corresponding apparatus for positioning a terminal to overcome or at least partially solve the above problem.

An aspect of the disclosure is directed to a method for determining a position of a terminal communicating with a first base station, the first base station communicating with at least one second base station. The method can include: acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame, wherein the ranging request frame is sent by the first base station to the terminal and the at least one second base station and the ranging acknowledgment frame is sent by the terminal to the first base station and the at least one second base station after receiving the ranging request frame; and determining location information of the terminal according to the first transceiving moment information.

Another aspect of the disclosure is directed to a method for determining a position of a terminal communicating with a first base station, the first base station communicating with at least one second base station. The method can include: acquiring second transceiving moment information, wherein the second transceiving moment information comprises a moment associated with the terminal sending a ranging request frame, a moment associated with the terminal receiving a ranging acknowledgment frame, a moment associated with the first base station sending the ranging acknowledgment frame, a moment associated with the first base station receiving the ranging request frame, at least one moment associated with the at least one second base station receiving the ranging acknowledgment frame, and at least one moment associated with the at least one second base station receiving the ranging request frame, wherein the ranging request frame is sent by the terminal to the first base station and the at least one second base station; and the ranging acknowledgment frame is sent by the first base station to the terminal and the at least one second base station after receiving the ranging request frame; and determining location information of the terminal according to the second transceiving moment information.

Yet another aspect of the disclosure is directed to an apparatus for determining a position of a terminal communicating with a first base station, the first base station communicating with at least one second base station. The apparatus can include: a memory storing a set of instructions; and at least one processor configured to execute the set of instructions to cause the apparatus to perform: acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame, wherein the ranging request frame is sent by the first base station to the terminal and the at least one second base station and the ranging acknowledgment frame is sent by the terminal to the first base station and the second base station after receiving the ranging request frame; and determining location information of the terminal according to the first transceiving moment information.

Yet another aspect of the disclosure is directed to an apparatus for determining a position of a terminal, wherein the terminal communicates with a first base station, and the first base station communicates with at least one second base station. The apparatus can include: a memory storing a set of instructions; and at least one processor configured to execute the set of instructions to cause the apparatus to perform: acquiring second transceiving moment information, wherein the second transceiving moment information comprises a moment associated with the terminal sending a ranging request frame, a moment associated with the terminal receiving a ranging acknowledgment frame, a moment associated with the first base station sending the ranging acknowledgment frame, a moment associated with the first base station receiving the ranging request frame, at least one moment associated with the at least one second base station receiving the ranging acknowledgment frame, and at least one moment associated with the at least one second base station receiving the ranging request frame, wherein the ranging request frame is sent by the terminal to the first base station and the at least one second base station; and the ranging acknowledgment frame is sent by the first base station to the terminal and the at least one second base station after receiving the ranging request frame; and determining location information of the terminal according to the second transceiving moment information.

Embodiments of the disclosure provide technical effects as below. In the positioning method according to the embodiments of the disclosure, the terminal does not send the ranging request frame to and receive the ranging acknowledgment frame from the plurality of base stations one by one. Instead, the terminal only receives a ranging request frame sent by one first base station and only sends the ranging acknowledgment frame once. The method reduces the power consumption required for sending the ranging request frame and receiving the ranging acknowledgment frame and does not rely on time synchronization between base stations, thus achieving a small time delay and accurate ranging.

### BRIEF DESCRIPTION OF THE DRAWINGS

FIG. 1 is a flowchart of a method for determining a position of a terminal, according to embodiments of the disclosure.

FIG. 2 is a flowchart of another method for determining a position of a terminal, according to embodiments of the disclosure.

FIG. 3 is a schematic diagram of a method for determining a position of a terminal, according to embodiments of an embodiment of the disclosure.

FIG. 4 is a schematic diagram of radio frame transceiving moments, according to embodiments of the disclosure.

FIG. 5 is a flowchart of yet another method for determining a position of a terminal, according to embodiments of the disclosure.

FIG. 6 is a flowchart of yet another method for determining a position of a terminal, according to embodiments of the disclosure.

FIG. 7 is a schematic diagram of a method for determining a position of a terminal, according to embodiments of the disclosure.

FIG. 8 is a flowchart of yet another method for determining a position of a terminal, according to the disclosure.

FIG. 9 is a flowchart of yet another method for determining a position of a terminal, according to embodiments of the disclosure.

FIG. 10 is a schematic diagram of an apparatus for determining a position of a terminal, according to embodiments of the disclosure.

FIG. 11 is a schematic diagram of an apparatus for determining a position of a terminal, according to embodiments of the disclosure.

### DETAILED DESCRIPTION

To make the above objectives, features and advantages of the present application more comprehensible, the present application is described in further detail below with reference to the accompanying drawings and specific implementations.

A LoRa network includes a terminal, a base station, and a server. The terminal can access the LoRa network. Depending on different application scenarios for which the LoRa network is deployed, the terminal may include different electronic devices. For example, when the LoRa network is applied to city management, the terminal may be a smart electric meters. When the LoRa network is applied to a digital home, the terminal may include various intelligent home appliances.

The base station (also referred to as a gateway or concentrator) in the LoRa network can have a wireless connection converging function, provide an entrance for the terminal to access the LoRa network, and forward data from a server or a terminal. Therefore, the base station can implement data exchange between the terminal and the server. It is appreciated that, the base station can also exchange data with other base stations within its signal coverage by transmitting radio frames.

The server may be configured to perform service processing according to data acquired from the base station or the terminal and control the working mode and status of the base station or the terminal. It is appreciated that the server can be a server cluster.

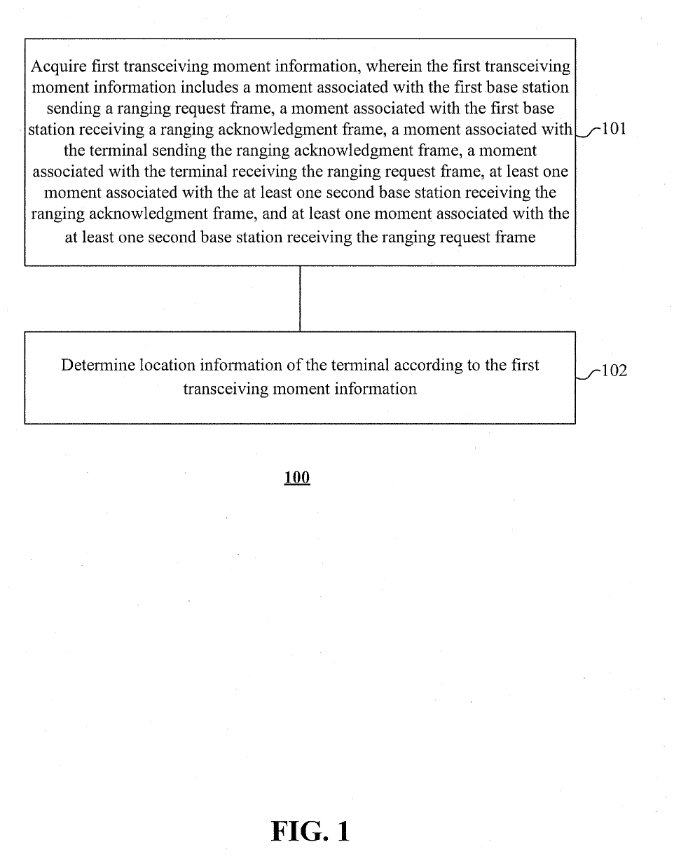

FIG. 1 is a flowchart of a method 100 for determining a position of a terminal, according to embodiments of the disclosure. The terminal communicates with a first base station, and the first base station communicates with at least one second base station. Method 100 may further include the following steps.

In step 101, the server acquires first transceiving moment information. The first transceiving moment information includes a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame. The ranging request frame is sent by the first base station to the terminal and the at least one second base station. The ranging acknowledgment frame is sent by the terminal to the first base station and the at least one second base station after receiving the ranging request frame.

In embodiments of the disclosure, the ranging request frame may be sent by the first base station to the terminal and the at least one second base station, simultaneously. The ranging acknowledgment frame may be sent by the terminal to the first base station and the at least one second base station, simultaneously, after receiving the ranging request frame.

In embodiments of the disclosure, the first base station may send the ranging request frame in a broadcast mode, and the terminal and at least one second base station can receive the ranging request frame.

The moment associated with the terminal receiving the ranging request frame is related to a distance from the terminal to the first base station. When the distance is longer, the transmission time of the ranging request frame is longer, and thus, the moment associated with the terminal receiving the ranging request frame is later.

The moment associated with the at least one second base station receiving the ranging request frame is related to a distance from the second base station to the first base station. When the distance is longer, the transmission time of the ranging request frame is longer, and thus, the moment associated with the second base station receiving the ranging request frame is later.

The terminal broadcasts a ranging acknowledgment frame after receiving the ranging request frame, and the first base station and the at least one second base station can receive the ranging acknowledgment frame.

The moment associated with the first base station receiving the ranging acknowledgment frame is related to the distance from the first base station to the terminal. When the distance is longer, the transmission time of the ranging acknowledgment frame is longer, and thus, the moment associated with the first base station receiving the ranging acknowledgment frame is later.

The moment associated with the second base station receiving the ranging acknowledgment frame is related to the distance from the second base station to the terminal. When the distance is longer, the transmission time of the ranging acknowledgment frame is longer, and thus, the moment associated with the second base station receiving the ranging acknowledgment frame is later.

In embodiments of the disclosure, the moment associated with the first base station sending the ranging request frame, the moment associated with the first base station receiving the ranging acknowledgment frame, the moment associated with the terminal sending the ranging acknowledgment frame, the moment associated with the terminal receiving the ranging request frame, the moments associated with the second base stations receiving the ranging acknowledgment frame, and the at least one moment associated with the second base station receiving the ranging request frame may be acquired by the server.

In embodiments of the disclosure, the moment associated with each radio frame (including the ranging request frame and the ranging acknowledgment frame) being sent may be the moment at which the radio frame is completely sent out.

The moment associated with each radio frame being received may be the moment at which the radio frame is just received.

In step 102, the server determines location information of the terminal according to the first transceiving moment information.

In embodiments of the disclosure, the location information of the terminal may be determined by the server according to the first transceiving moment information.

In the positioning method, the terminal does not send the ranging request frame to and receive the ranging acknowledgment frame from the plurality of base stations one by one. Instead, the terminal only receives a ranging request frame sent by one first base station and only sends the ranging acknowledgment frame once. The method reduces the power consumption required for sending the ranging request frame and receiving the ranging acknowledgment frame and does not rely on time synchronization between base stations, thus achieving a small time delay and accurate ranging.

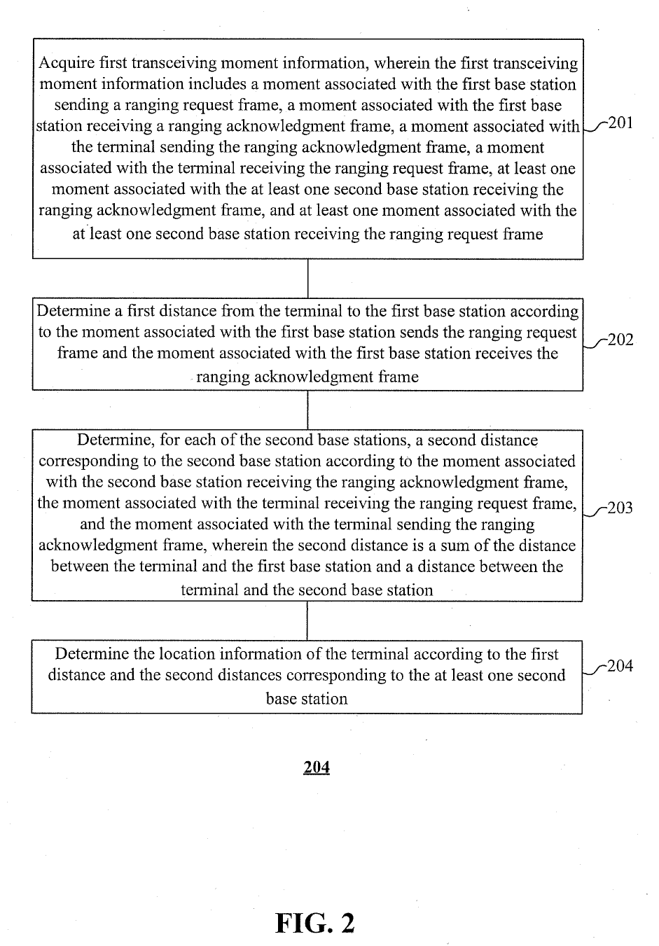

FIG. 2 is a flowchart of another method 200 for determining a position of a terminal, according to embodiments of the disclosure. The terminal communicates with a first base station, and the first base station communicates with at least one of second base stations. Method 200 may include the following steps.

In step 201, the server acquires first transceiving moment information. The first transceiving moment information includes a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moments associated with the at least one second base station receiving the ranging request frame. The ranging request frame is sent by the first base station to the terminal and the at least one second base station, and the ranging acknowledgment frame is sent by the terminal to the first base station and the at least one second base station after receiving the ranging request frame.

In embodiments of the disclosure, the ranging request frame may be sent by the first base station to the terminal and the at least one second base station, simultaneously. The ranging acknowledgment frame may be sent by the terminal to the first base station and the at least one second base station, simultaneously, after receiving the ranging request frame.

In embodiments of the disclosure, the first base station may send the ranging request frame in a broadcast mode, and the terminal and at least one of the second base stations can receive the ranging request frame.

The terminal broadcasts a ranging acknowledgment frame after receiving the ranging request frame, and the first base station and the at least one second base station can receive the ranging acknowledgment frame.

In embodiments of the disclosure, the first transceiving moment information may be acquired by a server.

In embodiments of the disclosure, the moment associated with each radio frame (including the ranging request frame and the ranging acknowledgment frame) being sent may be the moment at which the radio frame has been completely sent out.

The moment associated with each radio frame being received may be the moment at which the radio frame is just received.

In step 202, the server determines a first distance from the terminal to the first base station according to the moment associated with the first base station sending the ranging request frame and the moment associated with the first base station receiving the ranging acknowledgment frame.

For example, the first distance between the terminal and the first base station may be determined according to a Time of Arrival (TOA) algorithm by using the moment associated with the first base station sending the ranging request frame and the moment associated with the first base station receiving the ranging acknowledgment frame.

The first distance between the first base station and the terminal may be represented as D1x, the moment associated with the first base station sending the ranging request frame may be represented as T1, and the moment associated with the first base station receiving the ranging acknowledgment frame may be represented as Tx1.

An equation of the TOA algorithm may specifically be:

D1x=C*(Tx1−T)/2,

where Cis the speed of light.

In step 203, the server determines, for each of the at least one second base station, a second distance corresponding to the second base station according to the moment associated with the second base station receiving the ranging acknowledgment frame, the moment associated with the terminal receiving the ranging request frame, and the moment associated with the terminal sending the ranging acknowledgment frame. The second distance is a sum of the distance from the terminal to the first base station and a distance from the terminal to the second base station.

In embodiments of the disclosure, the sum of the distance from the terminal to the first base station and the distance from the terminal to the second base station is used as the second distance corresponding to the second base station. The second distance corresponding to each of the second base stations may be calculated according to the moment associated with the second base station receiving the ranging acknowledgment frame, the moment associated with the terminal receiving the ranging request frame, and the moment associated with the terminal sending the ranging acknowledgment frame.

In some embodiments, step 203 may further include: determining, for each of the at least one second base station, the second distance corresponding to the second base station according to the moment associated with the second base station receives the ranging acknowledgment frame, the moment associated with the first base station sending the ranging request frame, the moment associated with the terminal receiving the ranging request frame, and the moment associated with the terminal sending the ranging acknowledgment frame.

For example, the first base station may communicate with n second base stations, where n is equal to or greater than 1. The second distance corresponding to the second base station may be represented as Di, (2≤i≤1+n), the moment associated with the second base station receiving the ranging acknowledgment frame may be represented as Txi, the moment associated with the first base station sending the ranging request frame may be represented as T1, the moment associated with the terminal receiving the ranging request frame may be represented as T1x, and the moment associated with the terminal sending the ranging acknowledgment frame may be represented as Tx. The moment associated with the terminal sending the ranging acknowledgment frame minus the moment associated with the terminal receiving the ranging request frame may be represented as Δt(x), and Δt(x)=Tx-T1x. In fact, no frame is transmitted during the time interval Δt(x).

An equation of the algorithm may be:

Di=C*(Txi−T1−Δt(x)).

In the above equation, Txi−T1−Δt(x) represents the transmission time of the ranging request frame plus the transmission time of the ranging acknowledgment frame, and a product of the frame transmission time and the speed of light can represent the distance of frame transmission.

In another example, the first transceiving moment information may further include: the moments associated with the second base stations receiving the ranging request frame, and step 203 may further include: determining, for each of the second base stations, the second distance corresponding to the second base station according to a known distance between the second base station and the first base station, the moment associated with the second base station receiving the ranging request frame, the moment associated with the second base station receiving the ranging acknowledgment frame, the moment associated with the terminal receiving the ranging request frame, and the moment associated with the terminal sending the ranging acknowledgment frame.

For example, the first base station communicates with n second base stations, where n is equal to or greater than 1. The second distance corresponding to the second base station may be represented as Di, (2≤i≤1+n), the distance between the first base station and the second base station may be represented as D1i, the moment associated with the second base station receives the ranging request frame may be represented as T1i, the moment associated with the second base station receiving the ranging acknowledgment frame may be represented as Txi, the moment associated with the terminal receiving the ranging request frame may be represented as T1x, the moment associated with the terminal sending the ranging acknowledgment frame may be represented as Tx, and Δt(x)=Tx−T1x.

An equation of the algorithm may be:

Di=D1i+C*(Txi−T1i−Δt(x)).

When the distances between the second base stations and the first base station are known, the second distances of the second base stations may be calculated by using the algorithm of this example.

In step 204, the server determines the location information of the terminal according to the first distance and the second distances corresponding to the second base stations.

In embodiments of the disclosure, the first distance from the terminal to the first base station and the second distances corresponding to the second base stations may be calculated multiple times according to first transceiving moment information obtained in multiple ranging request frame and ranging acknowledgment transceiving procedures. Then, a mean of multiple first distances obtained is used as a final first distance, and a mean of multiple second distances obtained is used as a final second distance. Finally, the location information of the terminal is determined by using the first distance and the second distance.

In embodiments of the disclosure, the first distance from the terminal to the first base station and the second distances corresponding to the second base stations may also be calculated according to first transceiving moment information obtained in each ranging request frame and ranging acknowledgment transceiving procedure, and then the location information of the terminal is determined by using the first distance and the second distance. Finally, a mean of multiple pieces of location information obtained is used as the final location information of the terminal.

In embodiments of the disclosure, step 204 may include the following substeps.

In substep S11, the server determines a spherical surface corresponding to the first base station by using location information of the first base station as the center of circle and using the first distance as the radius. The spherical surface is determined by the center of circle and the radius, and a terminal at the first distance from the first base station is on the spherical surface.

In substep S12, the server determines, for each of the second base stations, an ellipsoidal surface corresponding to the second base station by using the location information of the first base station and location information of one of the second base stations as the focal points of the ellipsoidal surface and using the second distance as the major axis of the ellipsoidal surface. The ellipsoidal surface may be determined by the two focal points and the major axis, and a sum of distances from a point on the ellipsoidal surface to the two focal points is a length of the major axis. A terminal, a sum of distances from which to the first base station and to the second base station equals the second distance, is on the ellipsoidal surface.

In substep S13, the server determines location information of an intersection point of the spherical surface corresponding to the first base station and the ellipsoidal surfaces corresponding to the second base stations as the location information of the terminal. The intersection point of the spherical surface corresponding to the first base station and the ellipsoidal surfaces corresponding to the second base stations is unique. The location of the intersection point is the location of the terminal.

In the embodiments of the present application, if three-dimensional spatial positioning can be implemented, at least four base stations (including one first base station and three second base stations) are needed. When there is provided more base stations, the positioning error can be smaller and the positioning precision can be better.

If two-dimensional planer positioning can be implemented, at least three base stations (including one first base station and two second base stations) are needed.

If one-dimensional positioning can be implemented (for example, positioning in a tunnel), at least two base stations (including one first base station and one second base station) are needed.

In the positioning methods discussed above, the terminal does not send the ranging request frame to and receive the ranging acknowledgment frame from the plurality of base stations one by one. Instead, the terminal only receives a ranging request frame sent by one first base station and only sends the ranging acknowledgment frame once. The method reduces the power consumption required for sending the ranging request frame and receiving the ranging acknowledgment frame and does not rely on time synchronization between base stations, thus achieving a small time delay and accurate ranging.

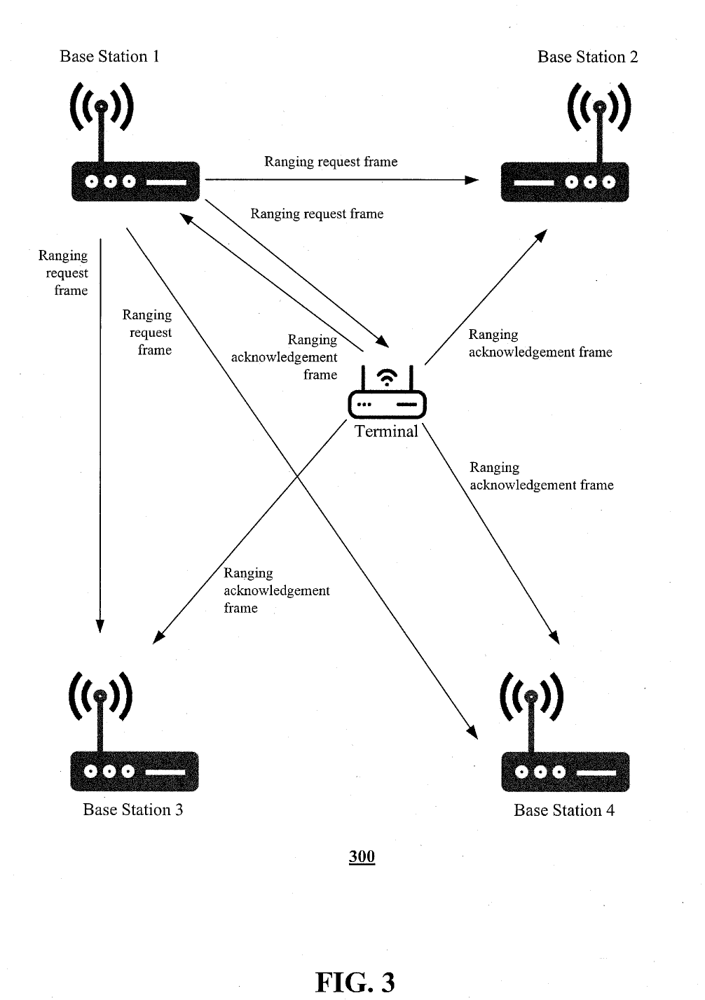

FIG. 3 is a schematic diagram of a method 300 for determining a position of a terminal, according to embodiments of an embodiment of the disclosure.

Base stations can include a base station 1, a base station 2, a base station 3 and a base station 4. A terminal may perform one ranging request frame and ranging acknowledgment frame transceiving procedure with the base station 1. It is appreciated that, a server can be provided to collection information from the base stations and the terminal to position the terminal.

The base station 1 sends a ranging request frame in broadcast mode. And the base station 2, the base station 3, the base station 4, and the terminal can receive the ranging request frame.

The terminal sends a ranging acknowledgment frame in a broadcast mode after receiving the ranging request frame. And the base station 1, the base station 2, the base station 3, and the base station 4 can receive the ranging acknowledgment frame.

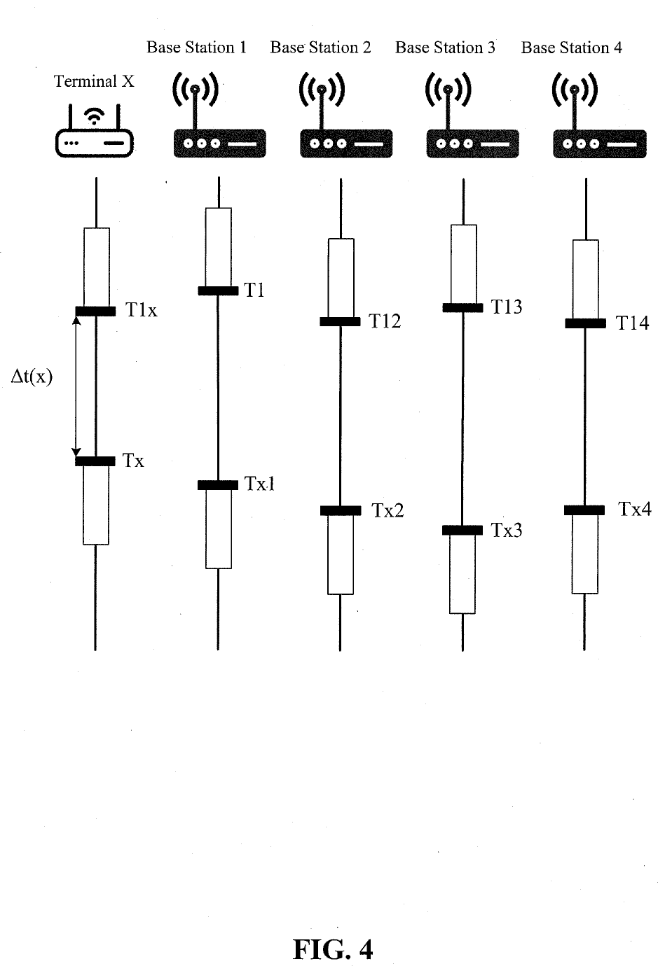

FIG. 4 is a schematic diagram of radio frame transceiving moments, according to embodiments of the disclosure. Radio frames include a ranging request frame and a ranging acknowledgment frame. The moment associated with the ranging request frame being sent is defined as the moment at which the ranging request frame has been completely sent out, the moment associated with the ranging acknowledgment frame being sent is defined as the moment at which the ranging request frame has been completely sent out, the moment associated with the ranging request frame being received is defined as the moment at which the ranging request frame is just received, and the moment associated with the ranging acknowledgment frame being received is defined as the moment at which the ranging acknowledgment frame is just received.

The moment associated with the terminal receiving the ranging request frame may be represented as T1x. The moment associated with the terminal sending the ranging acknowledgment frame may be represented as Tx.

The moment associated with the base station 1 sending the ranging request frame may be represented as T1. The moment associated with the base station 1 receiving the ranging acknowledgment frame may be represented as Tx1.

The moment associated with the base station 2 receiving the ranging request frame may be represented as T12. The moment associated with the base station 2 receiving the ranging acknowledgment frame may be represented as Tx2.

The moment associated with the base station 3 receiving the ranging request frame may be represented as T13. The moment associated with the base station 3 receiving the ranging acknowledgment frame may be represented as Tx3.

The moment associated with the base station 4 receiving the ranging request frame may be represented as T14. The moment associated with the base station 4 receiving the ranging acknowledgment frame may be represented as Tx4.

A distance between the base station 1 and the terminal may be represented as D1x.

According to a TOA algorithm, the distance between the base station 1 and the terminal may be D1x=C*(Tx1−T1)/2. A spherical surface corresponding to the base station 1 is determined by using the base station 1 as the center of circle and using D1x as the radius.

The moment associated with the terminal sending the ranging acknowledgment frame minus the moment associated with the terminal receiving the ranging request frame may be represented as Δt(x), and Δt(x)=Tx−T1x.

A sum of the distance between the terminal and the base station 1 and a distance between the terminal and the base station 2 may be represented as D2, and a distance between the base station 1 and the base station 2 between may be represented as D12. Then, D2=D12+C*(Tx2−T12−Δt(x)), or D2=C*(Tx2−T1−Δt(x)). An ellipsoidal surface corresponding to the base station 2 is determined by using the base station 1 and the base station 2 as the focal points and using D2 as the major axis.

A sum of the distance between the terminal and the base station 1 and a distance between the terminal and the base station 3 may be represented as D3, and a distance between the base station 1 and the base station 3 may be represented as D13. Then, D3=D13+C*(Tx3−T13−Δt(x)), or D3=C*(Tx3−T1−Δt(x)). An ellipsoidal surface corresponding to the base station 3 is determined by using the base station 1 and the base station 3 as the focal points and using D3 as the major axis. A sum of the distance between the terminal and the base station 1 and a distance between the terminal and the base station 4 may be represented as D4, and a distance between the base station 1 and the base station 4 may be represented as D14. Then, D4=D14+C*(Tx4−T14−Δt(x)), or D4=C*(Tx4−T1−Δt(x)). An ellipsoidal surface corresponding to the base station 4 is determined by using the base station 1 and the base station 4 as the focal points and using D4 as the major axis.

An intersection point of the spherical surface corresponding to the base station 1, the ellipsoidal surface corresponding to the base station 2, the ellipsoidal surface corresponding to the base station 3, and the ellipsoidal surface corresponding to the base station 4 is determined. The location of the intersection point is the location of the terminal.

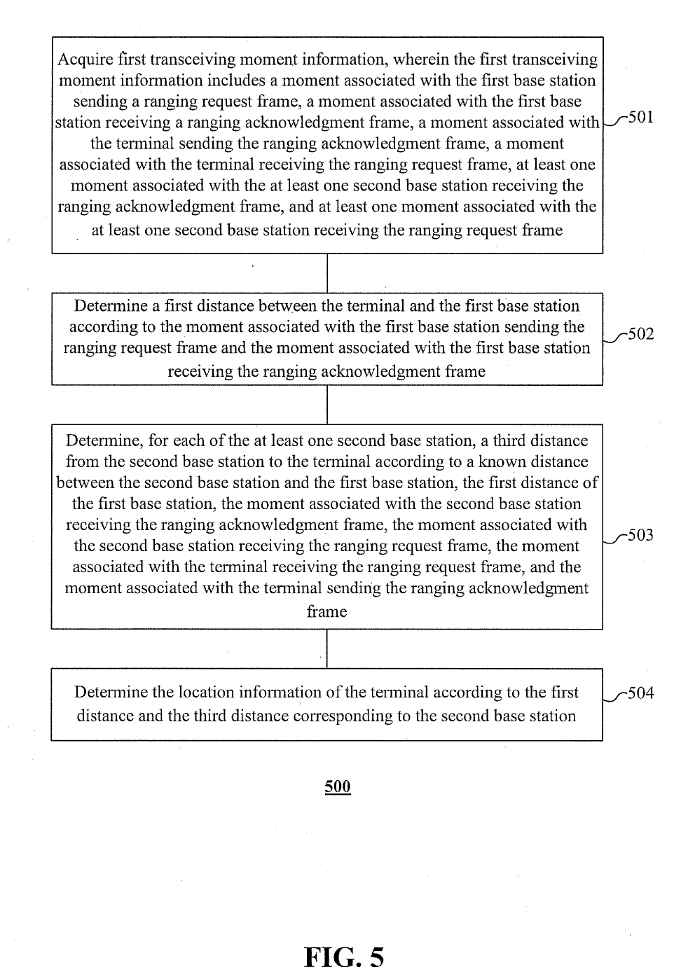

FIG. 5 is a flowchart of yet another method 500 for determining a position of a terminal, according to embodiments of the disclosure. The terminal communicates with one first base station, and the first base station communicates with at least one of second base stations. Method 500 may include the following steps.

In step 501, the server acquires first transceiving moment information. The first transceiving moment information includes a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame. The ranging request frame is sent by the first base station to the terminal and the at least one second base station, and the ranging acknowledgment frame is sent by the terminal to the first base station and the at least one second base station after receiving the ranging request frame.

In embodiments of the disclosure, the ranging request frame may be sent by the first base station simultaneously to the terminal and the at least one second base station, and the ranging acknowledgment frame may be sent by the terminal simultaneously to the first base station and the at least one second base station after receiving the ranging request frame.

In embodiments of the disclosure, the first base station may send the ranging request frame in broadcast mode, and the terminal and at least one second base station can receive the ranging request frame.

The terminal broadcasts a ranging acknowledgment frame after receiving the ranging request frame, and the first base station and at least one second base station can receive the ranging acknowledgment frame.

In embodiments of the disclosure, the first transceiving moment information may be acquired by a server.

In embodiments of the disclosure, the moment associated with each radio frame (including the ranging request frame and the ranging acknowledgment frame) being sent is defined in the same way, and may be the moment at which the radio frame has been completely sent out.

The moment associated with each radio frame being received is also defined in the same way, and may be the moment at which the radio frame is just received.

In step 502, the server determines a first distance from the terminal to the first base station according to the moment associated with the first base station sending the ranging request frame and the moment associated with the first base station receiving the ranging acknowledgment frame.

In some embodiments, the first distance between the terminal and the first base station may be calculated according to a Time of Arrival (TOA) algorithm by using the moment associated with the first base station sending the ranging request frame and the moment associated with the first base station receiving the ranging acknowledgment frame.

The first distance between the first base station and the terminal may be represented as D1x, the moment associated with the first base station sending the ranging request frame may be represented as T1, and the moment associated with the first base station receiving the ranging acknowledgment frame may be represented as Tx1.

An equation of the TOA algorithm may specifically be:

D1x=C*(Tx1−T1)/2,

where C is the speed of light.

In step 503, the server determines, for each of the second base stations, a third distance from the second base station to the terminal according to a known distance between the second base station and the first base station, the first distance of the first base station, the moment associated with the second base station receiving the ranging acknowledgment frame, the moment associated with the second base station receiving the ranging request frame, the moment associated with the terminal receiving the ranging request frame, and the moment associated with the terminal sending the ranging acknowledgment frame.

In some embodiments, the first base station may communicate with n second base stations, where n is equal to or greater than 1. The third distance from the second base station to the terminal may be represented as Dk, (2≤k≤1+n), the distance between the first base station and the second base station may be represented as D1k, the moment associated with the second base station receiving the ranging acknowledgment frame may be represented as Txk, the moment associated with the second base station receiving the ranging request frame may be represented as T1k, the moment associated with the terminal receiving the ranging request frame may be represented as T1x, the moment associated with the terminal sending the ranging acknowledgment frame may be represented as Tx, and Δt(x)=Tx−T1x.

An equation of the algorithm may specifically be:

Dk=D1x+C*(Txk−T1k−Δt(x))−D1k.

In step 504, the server determines the location information of the terminal according to the first distance and the third distances corresponding to the second base stations.

In embodiments of the disclosure, the first distance from the terminal to the first base station and the third distances from the terminal to the second base stations may be determined multiple times, according to first transceiving moment information obtained in multiple ranging request frame and ranging acknowledgment transceiving procedures. Then, a mean of multiple first distances obtained can be used as a final first distance, and a mean of multiple third distances obtained can be used as a final third distance. Finally, the location information of the terminal is determined by using the first distance and the third distance.

In embodiments of the disclosure, the first distance from the terminal to the first base station and the third distances from the terminal to the second base stations may also be calculated according to first transceiving moment information obtained in each ranging request frame and ranging acknowledgment transceiving procedure, and then the location information of the terminal is determined by using the first distance and the third distance; finally, a mean of multiple pieces of location information obtained is used as the final location information of the terminal.

In embodiments of the disclosure, step 504 may further include the following substeps.

In substep S21, the server determines a spherical surface corresponding to the first base station by using location information of the first base station as the center of circle and using the first distance as the radius. The spherical surface is determined by the center of circle and the radius, and a terminal at the first distance from the first base station is on the spherical surface.

In substep S22, the server determines, for each of the second base stations, a spherical surface corresponding to the second base station by using the location information of the second base station as the center of circle and using the corresponding third distance as the radius. The spherical surface is determined by the center of circle and the radius, and a terminal at the third distance from the second base station is on the spherical surface.

In substep S23, the server determines location information of an intersection point of the spherical surface corresponding to the first base station and the spherical surfaces corresponding to the second base stations as the location information of the terminal. The intersection point of the spherical surface corresponding to the first base station and the spherical surfaces corresponding to the second base stations is unique. The location of the intersection point is the location of the terminal.

In embodiments of the disclosure, if three-dimensional spatial positioning can be implemented, at least four base stations (including one first base station and three second base stations) are needed. When there is provided more base stations, the positioning error can be smaller and the positioning precision can be better.

If two-dimensional planer positioning can be implemented, at least three base stations (including one first base station and two second base stations) are needed.

If one-dimensional positioning can be implemented (for example, positioning in a tunnel), at least two base stations (including one first base station and one second base station) are needed.

In the positioning methods above, the terminal does not send the ranging request frame to and receive the ranging acknowledgment frame from the plurality of base stations one by one; instead, the terminal only can receive a ranging request frame sent by one first base station and only can send the ranging acknowledgment frame once. The method reduces the power consumption required for sending the ranging request frame and receiving the ranging acknowledgment frame and does not rely on time synchronization between base stations, thus achieving a small time delay and accurate ranging.

As shown in FIGS. 3 and 4, base stations include a base station 1, a base station 2, a base station 3 and a base station 4. A terminal may perform one ranging request frame and ranging acknowledgment frame transceiving procedure with the base station 1.

The base station 1 sends a ranging request frame in broadcast mode, and the base station 2, the base station 3, the base station 4 and the terminal can receive the ranging request frame.

The terminal x sends a ranging acknowledgment frame in broadcast mode after receiving the ranging request frame, and the base station 1, the base station 2, the base station 3 and the base station 4 can receive the ranging acknowledgment frame.

The moment associated with the base station 1 sending the ranging request frame may be represented as T1. The moment associated with the base station 1 receiving the ranging acknowledgment frame may be represented as Tx1.

The moment associated with the moment at which the terminal receiving the ranging request frame may be represented as T1x. The moment associated with the terminal sending the ranging acknowledgment frame may be represented as Tx.

The moment associated with the base station 2 receiving the ranging request frame may be represented as T12. The moment associated with the base station 2 receiving the ranging acknowledgment frame may be represented as Tx2.

The moment associated with the base station 3 receiving the ranging request frame may be represented as T13. The moment associated with the base station 3 receiving the ranging acknowledgment frame may be represented as Tx3.

The moment associated with the base station 4 receiving the ranging request frame may be represented as T14. The moment associated with the base station 4 receiving the ranging acknowledgment frame may be represented as Tx4.

A distance between the base station 1 and the terminal may be represented as D1x. According to a TOA algorithm, the distance between the base station 1 and the terminal may be D1x=C*(Tx1−T1)/2. A spherical surface corresponding to the base station 1 is determined by using the base station 1 as the center of circle and using D1x as the radius.

The moment associated with the terminal sending the ranging acknowledgment frame minus the moment associated with the terminal receiving the ranging request frame may be represented as Δt(x), and Δt(x)=Tx−T1x.

A distance between the terminal and the base station 2 may be represented as D2x, and a distance between the base station 1 and the base station 2 between may be represented as D12. According to the TOA algorithm, the distance between the base station 2 and the terminal may be D2x=Dlx+C*(Tx2−T12−Δt(x))−D12. A spherical surface corresponding to the base station 2 is determined by using the base station 2 as the center of circle and using D2x as the radius.

A distance between the terminal and the base station 3 may be represented as D3x, and a distance between the base station 1 and the base station 3 may be represented as D13. According to the TOA algorithm, the distance between the base station 3 and the terminal may be D3x=D1x+C*(Tx3−T13−Δt(x))−D13. A first spherical surface corresponding to the base station 3 is determined by using the base station 3 as the center of the spherical surface and using D3x as the radius of the spherical surface.

A distance between the terminal and the base station 4 may be represented as D4, and a distance between the base station 1 and the base station 4 may be represented as D14. According to the TOA algorithm, the distance between the base station 4 and the terminal may be D4x=D1x+C*(Tx4−T14−Δt(x))−D14. A spherical surface corresponding to the base station 4 is determined by using the base station 4 as the center of the spherical surface and using D4x as the radius of the spherical surface.

An intersection point of the spherical surface corresponding to the base station 1, the spherical surface corresponding to the base station 2, the spherical surface corresponding to the base station 3, and the spherical surface corresponding to the base station 4 is determined. The location of the intersection point is the location of the terminal.

In the above embodiments, the ranging request frame is sent by the first base station simultaneously to the terminal and the second base stations; and the ranging acknowledgment frame is sent by the terminal simultaneously to the first base station and the second base stations after receiving the ranging request frame.

Alternatively, the ranging request frame may be sent by the terminal to the first base station and the second base stations; and the ranging acknowledgment frame may be sent by the first base station to the terminal and the second base stations after receiving the ranging request frame. In this case, the principles of determining the location information of the terminal are the same as those in the above embodiments.

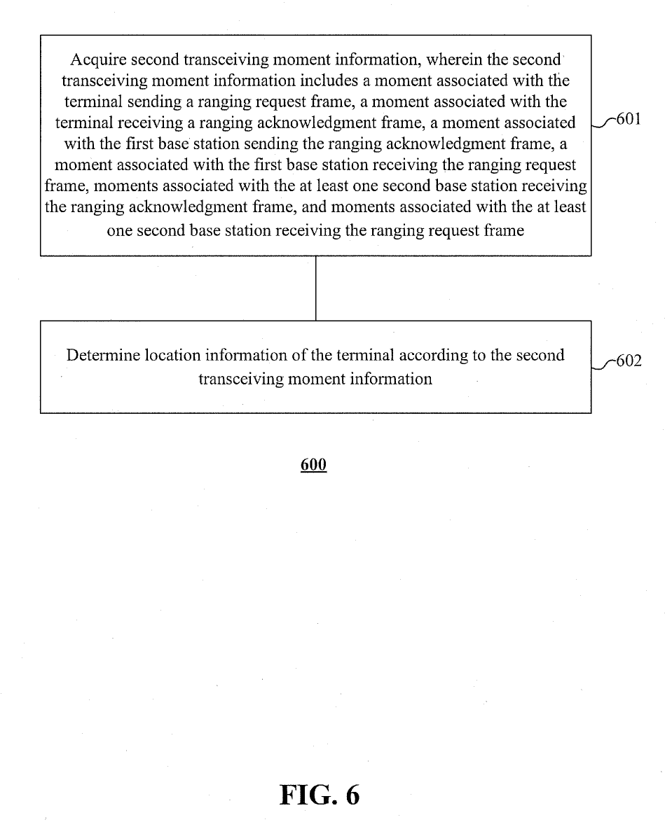

FIG. 6 is a flowchart of yet another method 600 for determining a position of a terminal, according to embodiments of the disclosure. The terminal communicates with one first base station, and the first base station communicates with at least one second base station. The method may include the following steps.

In step 601, the server acquires second transceiving moment information. The second transceiving moment information includes a moment associated with the terminal sending a ranging request frame, a moment associated with the terminal receiving a ranging acknowledgment frame, a moment associated with the first base station sending the ranging acknowledgment frame, a moment associated with the first base station receiving the ranging request frame, moments associated with the second base stations receiving the ranging acknowledgment frame, and moments associated with the second base stations receiving the ranging request frame. The ranging request frame is sent by the terminal to the first base station and the second base stations, and the ranging acknowledgment frame is sent by the first base station to the terminal and the second base stations after receiving the ranging request frame.

In embodiments of the disclosure, the ranging request frame may be sent by the terminal to the first base station and the second base stations, simultaneously. And the ranging acknowledgment frame may be sent by the first base station to the terminal and the second base stations, simultaneously, after receiving the ranging request frame.

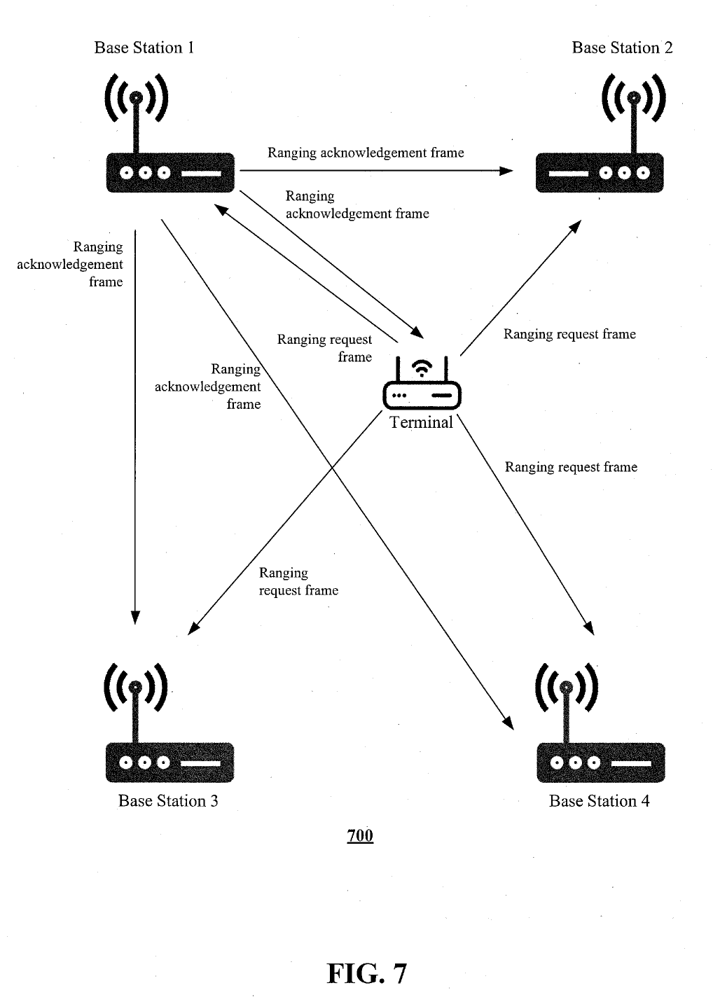

FIG. 7 is a schematic diagram of a method 700 for determining a position of a terminal, according to embodiments of the disclosure.

Base stations include a base station 1, a base station 2, a base station 3 and a base station 4. A terminal may perform one ranging request frame and ranging acknowledgment frame transceiving procedure with the base station 1.

The terminal sends a ranging request frame in broadcast mode, and base station 1, the base station 2, the base station 3 and the base station 4 can receive the ranging request frame.

The base station 1 sends a ranging acknowledgment frame in broadcast mode after receiving the ranging request frame, and the terminal, the base station 1, the base station 2 and the base station 3 can receive the ranging acknowledgment frame.

Referring back to FIG. 6, in step 602, the server determines location information of the terminal according to the second transceiving moment information.

In the positioning method of embodiments of the disclosure, the terminal does not send the ranging request frame to and receive the ranging acknowledgment frame from the plurality of base stations one by one; instead, the terminal only can send the ranging request frame once and only can receive a ranging acknowledgment frame sent by one first base station. The method reduces the power consumption required for sending the ranging request frame and receiving the ranging acknowledgment frame and does not rely on time synchronization between base stations, thus achieving a small time delay and accurate ranging.

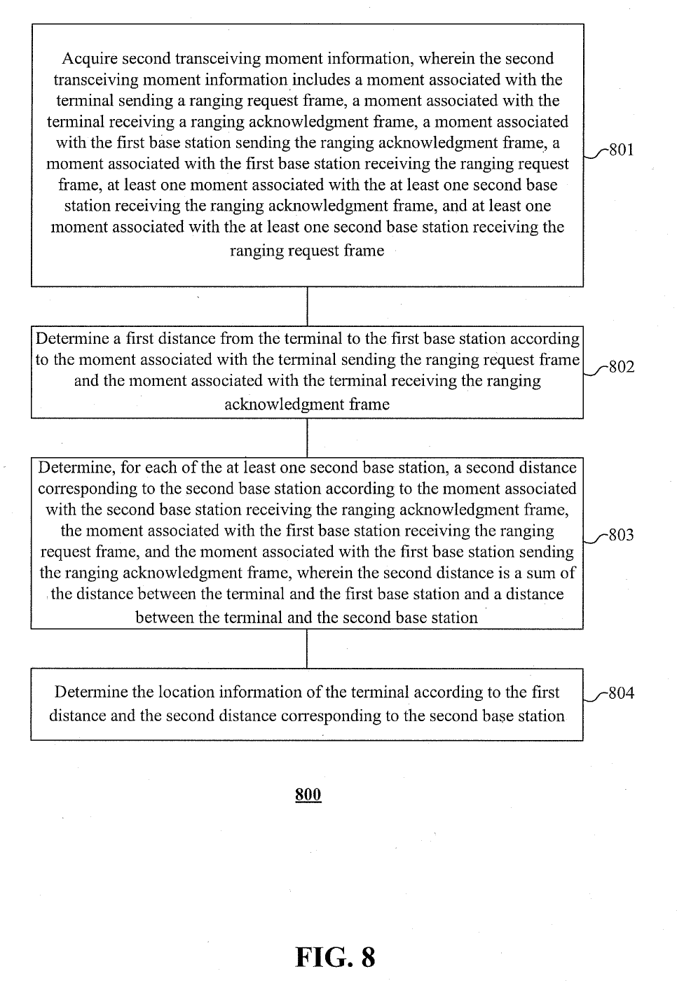

FIG. 8 is a flowchart of yet another method 800 for determining a position of a terminal, according to the disclosure. The terminal communicates with one first base station, and the first base station communicates with at least one second base station. Method 800 may include the following steps.

In step 801, the server acquires second transceiving moment information. The second transceiving moment information includes a moment at which the terminal sends a ranging request frame, a moment at which the terminal receives a ranging acknowledgment frame, a moment at which the first base station sends the ranging acknowledgment frame, a moment at which the first base station receives the ranging request frame, moments at which the second base stations receive the ranging acknowledgment frame, and moments at which the second base stations receive the ranging request frame; the ranging request frame is sent by the terminal to the first base station and the second base stations; and the ranging acknowledgment frame is sent by the first base station to the terminal and the second base stations after receiving the ranging request frame.

In embodiments of the disclosure, the ranging request frame may be sent by the terminal to the first base station and the second base stations, simultaneously. And the ranging acknowledgment frame may be sent by the first base station simultaneously to the terminal and the second base stations, simultaneously, after receiving the ranging request frame.

In step 802, the server determines a first distance from the terminal to the first base station according to the moment at which the terminal sends the ranging request frame and the moment at which the terminal receives the ranging acknowledgment frame.

In some embodiments, the first distance between the terminal and the first base station may be determined according to a Time of Arrival (TOA) algorithm by using the moment at which the terminal sends the ranging request frame and the moment at which the terminal receives the ranging acknowledgment frame.

The first distance between the first base station and the terminal may be represented as D1x, the moment at which the terminal sends the ranging request frame may be represented as Tx, and the moment at which the terminal receives the ranging acknowledgment frame may be represented as T1x.

An equation of the TOA algorithm may be:

D1x=C*(T1x−Tx)/2;

where, C is the speed of light.

In step 803, the server determines, for each of the second base stations, a second distance corresponding to the second base station according to the moment at which the second base station receives the ranging acknowledgment frame, the moment at which the first base station receives the ranging request frame, and the moment at which the first base station sends the ranging acknowledgment frame, wherein the second distance is a sum of the distance from the terminal to the first base station and a distance from the terminal to the second base station.

In an example of embodiments of the disclosure, step 803 may include:

determining, for each of the second base stations, the second distance corresponding to the second base station according to the moment at which the second base station receives the ranging acknowledgment frame, the moment at which the terminal sends the ranging request frame, the moment at which the first base station receives the ranging request frame, and the moment at which the first base station sends the ranging acknowledgment frame.

In some embodiments, the first base station may communicate with n second base stations, where n is equal to or greater than 1. The second distance corresponding to the second base station may be represented as Di, (2≤i≤1+n), the moment at which the second base station receives the ranging acknowledgment frame may be represented as T1i, the moment at which the terminal sends the ranging request frame may be represented as Tx, the moment at which the first base station receives the ranging request frame may be represented as Tx1, and the moment at which the first base station sends the ranging acknowledgment frame may be represented as T1. The moment at which the first base station sends the ranging acknowledgment frame minus the moment at which the first base station receives the ranging request frame may be represented as Δt(x), and Δt(x)=T1−Tx1. In fact, no frame is transmitted during the time interval Δt(x).

An equation of the algorithm may specifically be:

Di=C*(T1i−Tx−Δt(x));

In the above equation T1i−Tx−Δt(x) represents the transmission time of the ranging request frame plus the transmission time of the ranging acknowledgment frame, and a product of the frame transmission time and the speed of light can represent the distance of frame transmission.

In another example, the second transceiving moment information may further include the moments at which the second base stations receive the ranging request frame, and step 803 may further include: determining, for each of the second base stations, the second distance corresponding to the second base station according to a known distance between the second base station and the first base station, the moment at which the second base station receives the ranging request frame, the moment at which the second base station receives the ranging acknowledgment frame, the moment at which the first base station receives the ranging request frame, and the moment at which the first base station sends the ranging acknowledgment frame.

In some embodiments, the first base station communicates with n second base stations, where n is equal to or greater than 1. The second distance corresponding to the second base station may be represented as Di, (2≤i≤1+n), the distance between the first base station and the second base station may be represented as D1i, the moment at which the second base station receives the ranging request frame may be represented as Txi, the moment at which the second base station receives the ranging acknowledgment frame may be represented as T1i, the moment at which the first base station receives the ranging request frame may be represented as Tx1, the moment at which the first base station sends the ranging acknowledgment frame may be represented as T1, and Δt(x)=T1−Tx1.

An equation of the algorithm may be:

Di=D1i+C*(T1i−Txi−Δt(x)).

When the distances between the second base stations and the first base station are known, the second distances of the second base stations may be calculated by using the algorithm of this example.

In step 804, the server determines the location information of the terminal according to the first distance and the second distances corresponding to the second base stations.

In embodiments of the disclosure, the first distance from the terminal to the first base station and the second distances corresponding to the second base stations may be calculated multiple times according to second transceiving moment information obtained in multiple ranging request frame and ranging acknowledgment transceiving procedures; then, a mean of multiple first distances obtained is used as a final first distance, and a mean of multiple second distances obtained is used as a final second distance; finally, the location information of the terminal is determined by using the first distance and the second distance.

In embodiments of the disclosure, the first distance from the terminal to the first base station and the second distances corresponding to the second base stations may also be calculated according to second transceiving moment information obtained in each ranging request frame and ranging acknowledgment transceiving procedure, and then the location information of the terminal is determined by using the first distance and the second distance; finally, a mean of multiple pieces of location information obtained is used as the final location information of the terminal.

In embodiments of the disclosure, step 804 may include the following substeps.

In substep S31, the terminal determines a spherical surface corresponding to the first base station by using location information of the first base station as the center of circle and using the first distance as the radius.

In substep S32, the terminal determines, for each of the second base stations, an ellipsoidal surface corresponding to the second base station by using the location information of the first base station and location information of one of the second base stations as the focal points and using the second distance as the major axis.

In substep S33, the terminal determines location information of an intersection point of the spherical surface corresponding to the first base station and the ellipsoidal surfaces corresponding to the second base stations as the location information of the terminal.

In the embodiments above, if three-dimensional spatial positioning can be implemented, at least four base stations (including one first base station and three second base stations) are needed. When there is provided more base stations, the positioning error can be smaller and the positioning precision can be better.

If two-dimensional planer positioning can be implemented, at least three base stations (including one first base station and two second base stations) are needed.

If one-dimensional positioning can be implemented (for example, positioning in a tunnel), at least two base stations (including one first base station and one second base station) are needed.

In the positioning method of embodiments of the disclosure, the terminal does not send the ranging request frame to and receive the ranging acknowledgment frame from the plurality of base stations one by one. Instead, the terminal only sends the ranging request frame once and only receives a ranging acknowledgment frame sent by one first base station. The method reduces the power consumption required for sending the ranging request frame and receiving the ranging acknowledgment frame and does not rely on time synchronization between base stations, thus achieving a small time delay and accurate ranging.

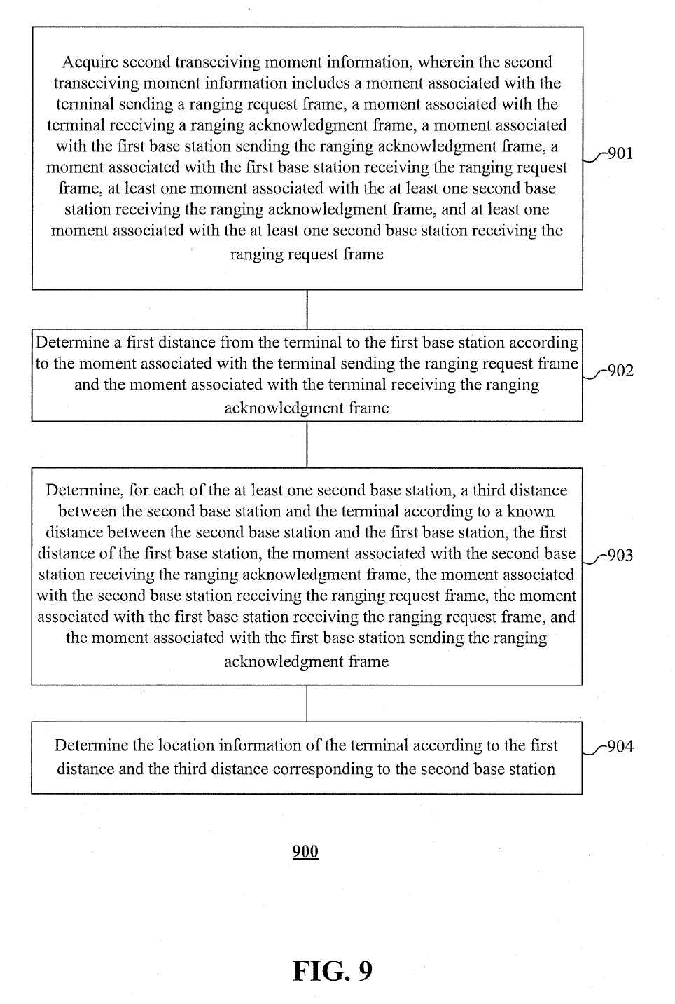

FIG. 9 is a flowchart of yet another method 900 for determining a position of a terminal, according to embodiments of the disclosure. The terminal communicates with one first base station, and the first base station communicates with at least one second base station. Method 900 may include the following steps.

In step 901, the server acquires second transceiving moment information. The second transceiving moment information includes a moment at which the terminal sends a ranging request frame, a moment at which the terminal receives a ranging acknowledgment frame, a moment at which the first base station sends the ranging acknowledgment frame, a moment at which the first base station receives the ranging request frame, moments at which the second base stations receive the ranging acknowledgment frame, and moments at which the second base stations receive the ranging request frame; the ranging request frame is sent by the terminal to the first base station and the second base stations; and the ranging acknowledgment frame is sent by the first base station to the terminal and the second base stations after receiving the ranging request frame.

In embodiments of the disclosure, the ranging request frame may be sent by the terminal simultaneously to the first base station and the second base stations; and the ranging acknowledgment frame may be sent by the first base station simultaneously to the terminal and the second base stations after receiving the ranging request frame.

In step 902, the server determines a first distance from the terminal to the first base station according to the moment at which the terminal sends the ranging request frame and the moment at which the terminal receives the ranging acknowledgment frame.

In some embodiments, the first distance between the terminal and the first base station may be determined according to a Time of Arrival (TOA) algorithm by using the moment at which the terminal sends the ranging request frame and the moment at which the terminal receives the ranging acknowledgment frame.

The first distance between the first base station and the terminal may be represented as D1x, the moment at which the terminal sends the ranging request frame may be represented as Tx, and the moment at which the terminal receives the ranging acknowledgment frame may be represented as T1x.

An equation of the TOA algorithm may be:

D1x=C*(T1x−Tx)/2,

where C is the speed of light.

In step 903, the server determines, for each of the second base stations, a third distance from the second base station to the terminal according to a known distance between the second base station and the first base station, the first distance of the first base station, the moment at which the second base station receives the ranging acknowledgment frame, the moment at which the second base station receives the ranging request frame, the moment at which the first base station receives the ranging request frame, and the moment at which the first base station sends the ranging acknowledgment frame.

In some embodiments, the first base station may communicate with n second base stations, where n is equal to or greater than 1. The third distance from the second base station to the terminal may be represented as Dk, (2≤k≤1+n), the distance between the first base station and the second base station may be represented as D1k, the moment at which the second base station receives the ranging acknowledgment frame may be represented as T1k, the moment at which the second base station receives the ranging request frame may be represented as Txk, the moment at which the first base station receives the ranging request frame may be represented as Tx1, the moment at which the first base station sends the ranging acknowledgment frame may be represented as T1, and Δt(x)=T1−Tx1.

An equation of the algorithm may be:

Dk=D1x+C*(T1k−Txk−Δt(x))−D1k.

In step 904, the server determines the location information of the terminal according to the first distance and the third distances corresponding to the second base stations.

In embodiments of the disclosure, the first distance from the terminal to the first base station and the third distances from the terminal to the second base stations may be determined multiple times according to second transceiving moment information obtained in multiple ranging request frame and ranging acknowledgment transceiving procedures. Then, a mean of multiple first distances obtained is used as a final first distance, and a mean of multiple third distances obtained is used as a final third distance. Finally, the location information of the terminal is determined by using the first distance and the third distance.

In embodiments of the disclosure, the first distance from the terminal to the first base station and the third distances from the terminal to the second base stations may also be calculated according to second transceiving moment information obtained in each ranging request frame and ranging acknowledgment transceiving procedure, and then the location information of the terminal is determined by using the first distance and the third distance. Finally, a mean of multiple pieces of location information obtained is used as the final location information of the terminal.

In embodiments of the disclosure, step 904 may include the following substeps.

In substep S41, the terminal determines a spherical surface corresponding to the first base station by using location information of the first base station as the center of circle and using the first distance as the radius.

In substep S42, the terminal determines, for each of the second base stations, a spherical surface corresponding to the second base station by using the location information of the second base station as the center of circle and using the corresponding third distance as the radius.

In substep S43, the terminal determines location information of an intersection point of the spherical surface corresponding to the first base station and the spherical surfaces corresponding to the second base stations as the location information of the terminal. The intersection point of the spherical surface corresponding to the first base station and the spherical surfaces corresponding to the second base stations is unique. The location of the intersection point is the location of the terminal.

In the embodiments above, if three-dimensional spatial positioning can be implemented, at least four base stations (including one first base station and three second base stations) are needed. When there is provided more base stations, the positioning error can be smaller and the positioning precision can be better.

If two-dimensional planer positioning can be implemented, at least three base stations (including one first base station and two second base stations) are needed.

If one-dimensional positioning can be implemented (for example, positioning in a tunnel), at least two base stations (including one first base station and one second base station) are needed.

In the positioning method of embodiments of the disclosure, the terminal does not send the ranging request frame to and receive the ranging acknowledgment frame from the plurality of base stations one by one. Instead, the terminal only sends the ranging request frame once and only receives a ranging acknowledgment frame sent by one first base station. The method reduces the power consumption required for sending the ranging request frame and receiving the ranging acknowledgment frame and does not rely on time synchronization between base stations, thus achieving a small time delay and accurate ranging.

It should be noted that for simplicity, the method embodiment are described as a series of action combinations, but it should be understood by those skilled in the art that the embodiments of the present application are not limited to the described order of actions, because some steps may be performed in a different order or simultaneously according to the embodiments of the present application. It should also be understood by those skilled in the art that the embodiments described in the specification are all preferred embodiments, and the actions involved in these embodiments may not be necessary for the embodiments of the present application.

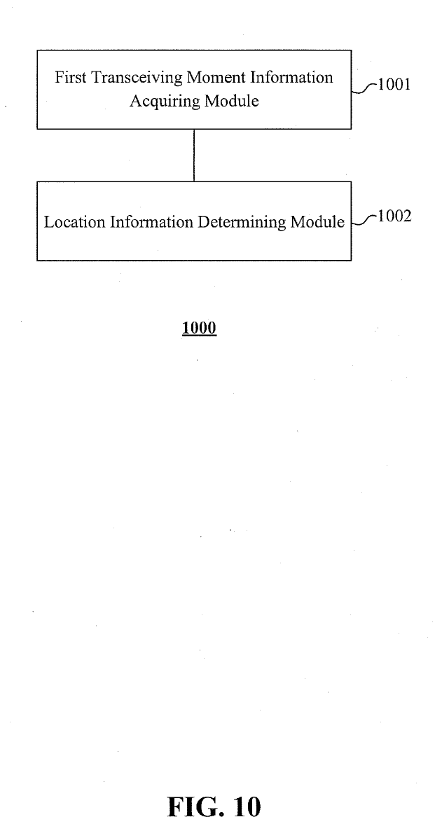

FIG. 10 is a schematic block diagram of an apparatus 1000 for determining a position of a terminal, according to embodiments of the disclosure. Apparatus 1000 can be the server discussed above. In some embodiments, apparatus 1000 can include a memory storing a set of instructions, and at least one processor configured to execute the set of instructions to cause the apparatus to perform the above methods. The terminal communicates with a first base station, and the first base station communicates with at least one of second base stations, apparatus 1000 may include the following modules.

A first transceiving moment information acquiring module 1001 can configured to acquire first transceiving moment information. The first transceiving moment information includes a moment at which the first base station sends a ranging request frame, a moment at which the first base station receives a ranging acknowledgment frame, a moment at which the terminal sends the ranging acknowledgment frame, a moment at which the terminal receives the ranging request frame, moments at which the second base stations receive the ranging acknowledgment frame, and moments at which the second base stations receive the ranging request frame; the ranging request frame is sent by the first base station to the terminal and the second base stations; and the ranging acknowledgment frame is sent by the terminal to the first base station and the second base stations after receiving the ranging request frame; and

A location information determining module 1002 can be configured to determine location information of the terminal according to the first transceiving moment information.

In embodiments of the disclosure, the location information determining module 1002 may include: a first distance calculation submodule, a second distance calculation submodule, and a first location information determining submodule.

The first distance calculation submodule can be configured to determine a first distance from the terminal to the first base station according to the moment at which the first base station sends the ranging request frame and the moment at which the first base station receives the ranging acknowledgment frame.

The second distance calculation submodule can be configured to determine, for each of the second base stations, a second distance corresponding to the second base station according to the moment at which the second base station receives the ranging acknowledgment frame, the moment at which the terminal receives the ranging request frame, and the moment at which the terminal sends the ranging acknowledgment frame, wherein the second distance is a sum of the distance from the terminal to the first base station and a distance from the terminal to the second base station.

The first location information determining submodule can be configured to determine the location information of the terminal according to the first distance and the second distances corresponding to the second base stations.

In an example of embodiments of the disclosure, the second distance calculation submodule may include: a first distance calculation unit.

The first distance calculation unit can be configured to determine, for each of the second base stations, the second distance corresponding to the second base station according to the moment at which the second base station receives the ranging acknowledgment frame, the moment at which the first base station sends the ranging request frame, the moment at which the terminal receives the ranging request frame, and the moment at which the terminal sends the ranging acknowledgment frame.

In another example, the first transceiving moment information further includes the moments at which the second base stations receive the ranging request frame, and the second distance calculation submodule includes: a second distance calculation unit.

The second distance calculation unit can be configured to determine, for each of the second base stations, the second distance corresponding to the second base station according to a known distance between the second base station and the first base station, the moment at which the second base station receives the ranging request frame, the moment at which the second base station receives the ranging acknowledgment frame, the moment at which the terminal receives the ranging request frame, and the moment at which the terminal sends the ranging acknowledgment frame.

In embodiments of the disclosure, the first location information determining submodule includes: a first spherical surface determining unit, an ellipsoidal surface determining unit, and a first location information determining unit. The first spherical surface determining unit can be configured to determine a spherical surface corresponding to the first base station by using location information of the first base station as the center of circle and using the first distance as the radius.

The ellipsoidal surface determining unit can be configured to determine, for each of the second base stations, an ellipsoidal surface corresponding to the second base station by using the location information of the first base station and location information of one of the second base stations as the focal points and using the second distance as the major axis.

The first location information determining unit can be configured to determine location information of an intersection point of the spherical surface corresponding to the first base station and the ellipsoidal surfaces corresponding to the second base stations as the location information of the terminal.

In embodiments of the disclosure, the location information determining module 1002 may include: a third distance calculation submodule, a fourth distance calculation submodule, and a second location information determining submodule.

The third distance calculation submodule can be configured to determine a first distance from the terminal to the first base station according to the moment at which the first base station sends the ranging request frame and the moment at which the first base station receives the ranging acknowledgment frame.

The fourth distance calculation submodule can be configured to calculate, for each of the second base stations, a third distance from the second base station to the terminal according to a known distance between the second base station and the first base station, the first distance of the first base station, the moment at which the second base station receives the ranging acknowledgment frame, the moment at which the second base station receives the ranging request frame, the moment at which the terminal receives the ranging request frame, and the moment at which the terminal sends the ranging acknowledgment frame; and

The second location information determining submodule can be configured to determine the location information of the terminal according to the first distance and the third distances corresponding to the second base stations.

In embodiments of the disclosure, the second location information determining submodule may include: a second spherical surface determining unit, a third spherical surface determining unit, and a second location information determining unit.

The second spherical surface determining unit can be configured to determine a spherical surface corresponding to the first base station by using location information of the first base station as the center of circle and using the first distance as the radius;

The third spherical surface determining unit can be configured to determine, for each of the second base stations, a spherical surface corresponding to the second base station by using the location information of the second base station as the center of circle and using the corresponding third distance as the radius; and

The second location information determining unit can be configured to determine location information of an intersection point of the spherical surface corresponding to the first base station and the spherical surfaces corresponding to the second base stations as the location information of the terminal.

In embodiments of the disclosure, the ranging request frame is sent by the first base station to the terminal and the second base stations, simultaneously. And the ranging acknowledgment frame is sent by the terminal to the first base station and the second base stations, simultaneously, after receiving the ranging request frame.

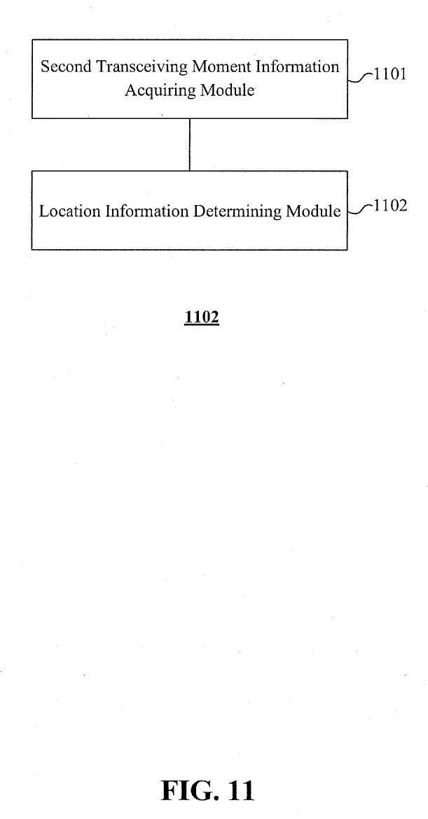

FIG. 11 is a schematic block diagram of an apparatus 1100 for determining a position of a terminal, according to embodiments of the disclosure. Apparatus 1100 can be the server discussed above. In some embodiments, apparatus 1100 can include a memory storing a set of instructions, and at least one processor configured to execute the set of instructions to cause the apparatus to perform the above methods. The terminal communicates with a first base station, and the first base station communicates with at least one of second base stations. The apparatus may include the following modules.

A second transceiving moment information acquiring module 1101 can be configured to acquire second transceiving moment information. The second transceiving moment information includes a moment at which the terminal sends a ranging request frame, a moment at which the terminal receives a ranging acknowledgment frame, a moment at which the first base station sends the ranging acknowledgment frame, a moment at which the first base station receives the ranging request frame, moments at which the second base stations receive the ranging acknowledgment frame, and moments at which the second base stations receive the ranging request frame; the ranging request frame is sent by the terminal to the first base station and the second base stations; and the ranging acknowledgment frame is sent by the first base station to the terminal and the second base stations after receiving the ranging request frame; and

A location information determining module 1102 can be configured to determine location information of the terminal according to the second transceiving moment information.

In embodiments of the disclosure, the location information determining module 1102 may include: a first distance calculation submodule, a second distance calculation submodule, and a first location information determining submodule.

The first distance calculation submodule can be configured to calculate a first distance from the terminal to the first base station according to the moment at which the terminal sends the ranging request frame and the moment at which the terminal receives the ranging acknowledgment frame.

The second distance calculation submodule can be configured to calculate, for each of the second base stations, a second distance corresponding to the second base station according to the moment at which the second base station receives the ranging acknowledgment frame, the moment at which the first base station receives the ranging request frame, and the moment at which the first base station sends the ranging acknowledgment frame, wherein the second distance is a sum of the distance from the terminal to the first base station and a distance from the terminal to the second base station.

The first location information determining submodule can be configured to determine the location information of the terminal according to the first distance and the second distances corresponding to the second base stations.

In an example of embodiments of the disclosure, the second distance calculation submodule may include: a first distance calculation unit.

The first distance calculation unit can be configured to calculate, for each of the second base stations, the second distance corresponding to the second base station according to the moment at which the second base station receives the ranging acknowledgment frame, the moment at which the terminal sends the ranging request frame, the moment at which the first base station receives the ranging request frame, and the moment at which the first base station sends the ranging acknowledgment frame.

In embodiments of the disclosure, the second transceiving moment information further includes the moments at which the second base stations receive the ranging request frame, and the second distance calculation submodule may include: a second distance calculation unit.

The second distance calculation unit can be configured to determine, for each of the second base stations, the second distance corresponding to the second base station according to a known distance between the second base station and the first base station, the moment at which the second base station receives the ranging request frame, the moment at which the second base station receives the ranging acknowledgment frame, the moment at which the first base station receives the ranging request frame, and the moment at which the first base station sends the ranging acknowledgment frame.

In embodiments of the disclosure, the first location information determining submodule may include: a first spherical surface determining unit, an ellipsoidal surface determining unit, and a first location information determining unit. The first spherical surface determining unit can be configured to determine a spherical surface corresponding to the first base station by using location information of the first base station as the center of circle and using the first distance as the radius.

The ellipsoidal surface determining unit can be configured to determine, for each of the second base stations, an ellipsoidal surface corresponding to the second base station by using the location information of the first base station and location information of one of the second base stations as the focal points and using the second distance as the major axis.

The first location information determining unit can be configured to determine location information of an intersection point of the spherical surface corresponding to the first base station and the ellipsoidal surfaces corresponding to the second base stations as the location information of the terminal.

In embodiments of the disclosure, the location information determining module 802 may include: a third distance calculation submodule, a fourth distance calculation submodule, and a second location information determining submodule.

The third distance calculation submodule can be configured to calculate a first distance from the terminal to the first base station according to the moment at which the terminal sends the ranging request frame and the moment at which the terminal receives the ranging acknowledgment frame.

The fourth distance calculation submodule can be configured to calculate, for each of the second base stations, a third distance from the second base station to the terminal according to a known distance between the second base station and the first base station, the first distance of the first base station, the moment at which the second base station receives the ranging acknowledgment frame, the moment at which the second base station receives the ranging request frame, the moment at which the first base station receives the ranging request frame, and the moment at which the first base station sends the ranging acknowledgment frame.

The second location information determining submodule can be configured to determine the location information of the terminal according to the first distance and the third distances corresponding to the second base stations.

In embodiments of the disclosure, the second location information determining submodule may include: a second spherical surface determining unit, a third spherical surface determining unit, and a second location information determining unit.

The second spherical surface determining unit can be configured to determine a spherical surface corresponding to the first base station by using location information of the first base station as the center of circle and using the first distance as the radius.

The third spherical surface determining unit can be configured to determine, for each of the second base stations, a spherical surface corresponding to the second base station by using the location information of the second base station as the center of circle and using the corresponding third distance as the radius.

The second location information determining unit can be configured to determine location information of an intersection point of the spherical surface corresponding to the first base station and the spherical surfaces corresponding to the second base stations as the location information of the terminal.

In embodiments of the disclosure, the ranging request frame is sent by the terminal simultaneously to the first base station and the second base stations; and the ranging acknowledgment frame is sent by the first base station simultaneously to the terminal and the second base stations after receiving the ranging request frame.

The device embodiment provides functionality that is basically similar to the functionality provided by the method embodiment and therefore is described briefly, and for the relevant part, reference may be made to the description of the part of the method embodiment.

The embodiments of the present application further provide an apparatus, including:

one or more processors; and

one or more machine readable media storing instructions which, when executed by the one or more processors, cause the apparatus to perform the method according to the embodiments of the present application.

The embodiments of the present application further provide one or more machine readable media storing instructions which, when executed by one or more processors of a device, cause the device to perform the method according to the embodiments of the present application.

The embodiments in the specification are described in a progressive manner. Each embodiment focuses on differences from other embodiments. For same or similar parts in the embodiments, reference may be made to each other.

As will be appreciated by those skilled in the art, the embodiments of the present application may be embodied as a method, a system, or a computer program product. Accordingly, the present application may use the form of an entire hardware embodiment, an entire software embodiment or an embodiment combining software and hardware aspects. Furthermore, the embodiments of the present application may use the form of a computer program product implemented on one or more computer-usable storage media (including but not limited to magnetic disk memories, CD-ROMs, optical memories, etc.) including computer-usable program code.

The embodiments of the present application are described with reference to flowcharts and/or block diagrams of the method, terminal device (system) and computer program product in the embodiments of the present application. It should be understood that computer program instructions can implement each process and/or block in the flowcharts and/or block diagrams and a combination of processes and/or blocks in the flowcharts and/or block diagrams. These computer program instructions may be provided to a general-purpose computer, a special-purpose computer, an embedded processor or a processor of another programmable data processing terminal device to generate a machine, so that an apparatus configured to implement functions specified in one or more processes in the flowcharts and/or one or more blocks in the block diagrams is generated by using instructions executed by the general-purpose computer or the processor of another programmable data processing terminal device.

These computer program instructions may also be stored in a computer readable memory that can guide a computer or another programmable data processing terminal device to work in a specified manner, so that the instructions stored in the computer readable memory generate a product including an instruction apparatus, where the instruction apparatus implements functions specified in one or more processes in the flowcharts and/or one or more blocks in the block diagrams.

These computer program instructions may also be loaded into a computer or another programmable data processing terminal device, so that a series of operation steps are performed on the computer or another programmable terminal device to generate processing implemented by a computer, and instructions executed on the computer or another programmable data processing terminal device provide steps for implementing functions specified in one or more processes in the flowcharts and/or one or more blocks in the block diagrams.

Although preferred embodiments of the present invention have been described, those skilled in the art can make additional variations or modifications to the embodiments after learning the basic inventive concept. Therefore, the appended claims should be construed as including the preferred embodiments and all variations and modifications that fall within the scope of the embodiments of the present invention.

Finally, it should be further noted that as used herein, relational terms such as first and second are merely used for distinguishing one entity or operation from another entity or operation, and do not necessarily require or imply any actual relationship or sequence between entities or operations. In addition, the terms “include,” “comprise” or any other variation thereof are intended to cover a non-exclusive inclusion, such that a process, method, article, or device that includes a list of elements not only includes those elements but also includes other elements not expressly listed or elements inherent to such process, method, article, or device. An element defined by “comprising a/an,” or the like does not, without more constraints, preclude the existence of additional identical elements in the process, method, article, or device that includes the element.

The method and apparatus for positioning a terminal that are provided by the present application are described in detail above. Specific examples are used in the specification to elaborate on the principle and implementation of the present application. However, the descriptions of the foregoing embodiments are merely used to facilitate the understanding of the method and core idea of the present application. Those of ordinary skill in the art can make modifications to the specific implementation and the application scope according to the idea of the present application. Therefore, the content of the specification should not be construed as limiting the present application.

1. A method for determining a position of a terminal communicating with a first base station, the first base station communicating with at least one second base station, the method comprising:
acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame, wherein the ranging request frame is sent by the first base station to the terminal and the at least one second base station and the ranging acknowledgment frame is sent by the terminal to the first base station and the at least one second base station after receiving the ranging request frame; and
determining location information of the terminal according to the first transceiving moment information.

2. The method according to claim 1, wherein determining the location information of the terminal according to the first transceiving moment information comprises:
determining a first distance between the terminal and the first base station according to the moment associated with the first base station sending the ranging request frame and the moment associated with the first base station receiving the ranging acknowledgment frame;
determining, for each of the at least one second base station, a second distance corresponding to the second base station according to the at least one moment associated with the second base station receiving the ranging acknowledgment frame, the moment associated with the terminal receiving the ranging request frame, and the moment associated with the terminal sending the ranging acknowledgment frame, wherein the second distance is a sum of the first distance and a distance between the terminal and the second base station; and
determining the location information of the terminal according to the first distance and the second distance corresponding to the second base station.

3. The method according to claim 1, wherein determining, for each of the at least one second base station, the second distance corresponding to the second base station further comprises:
determining, for each of the at least one second base station, the second distance corresponding to the second base station according to the at least one moment associated with the at least one second base station receiving the ranging acknowledgment frame, the moment associated with the first base station sending the ranging request frame, the moment associated with the terminal receiving the ranging request frame, and the moment associated with the terminal sending the ranging acknowledgment frame.

4. The method according to claim 1, wherein the first transceiving moment information further comprises the at least one moment associated with the at least one second base station receiving the ranging request frame, and determining, for each of the at least one second base station, the second distance corresponding to the second base station further comprises:
determining, for each of the at least one second base station, the second distance corresponding to the second base station according to a known distance between the second base station and the first base station, the moment associated with the second base station receiving the ranging request frame, the moment associated with the second base station receiving the ranging acknowledgment frame, the moment associated with the terminal receiving the ranging request frame, and the moment associated with the terminal sending the ranging acknowledgment frame.

5. The method according to claim 3, wherein determining the location information of the terminal according to the first distance and the second distance corresponding to the second base station comprises:
determining a spherical surface corresponding to the first base station by using location information of the first base station as the center of circle and using the first distance as the radius;
determining, for each of the at least one second base station, an ellipsoidal surface corresponding to the second base station by using the location information of the first base station and location information of the second base station as focal point of the ellipsoidal surface and using the second distance as a major axis of the ellipsoidal surface; and
determining location information of an intersection point of the spherical surface and the ellipsoidal surface corresponding to the second base station as the location information of the terminal.

6. The method according to claim 1, wherein determining the location information of the terminal according to the first transceiving moment information further comprises:
determining a first distance between the terminal and the first base station according to the moment associated with the first base station sending the ranging request frame and the moment associated with the first base station receiving the ranging acknowledgment frame;
determining, for each of the at least one second base station, a third distance between the second base station and the terminal according to a known distance between the second base station and the first base station, the first distance of the first base station, the moment associated with the second base station receiving the ranging acknowledgment frame, the moment associated with the second base station receiving the ranging request frame, the moment associated with the terminal receiving the ranging request frame, and the moment associated with the terminal sending the ranging acknowledgment frame; and
determining the location information of the terminal according to the first distance and the third distance corresponding to the second base station.

7. The method according to claim 6, wherein determining the location information of the terminal according to the first distance and the third distance corresponding to the second base station comprises:
determining a first spherical surface corresponding to the first base station by using location information of the first base station as a center of the first spherical surface and using the first distance as a radius of the first spherical surface;
determining, for each of the at least one second base station, a second spherical surface corresponding to the second base station by using the location information of the second base station as a center of the second spherical surface and using the corresponding third distance as a radius of the second spherical surface; and
determining location information of an intersection point of the first spherical surface and the second spherical surfaces as the location information of the terminal.

8. The method according to claim 1, wherein
the ranging request frame is sent by the first base station to the terminal and the at least one second base station, simultaneously, and
the ranging acknowledgment frame is sent by the terminal to the first base station and the at least one second base station, simultaneously, after receiving the ranging request frame.

9-16. (canceled)

17. An apparatus for determining a position of a terminal communicating with a first base station, the first base station communicating with at least one second base station, the apparatus comprising:
a memory storing a set of instructions; and
at least one processor configured to execute the set of instructions to cause the apparatus to perform:
acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame, wherein the ranging request frame is sent by the first base station to the terminal and the at least one second base station and the ranging acknowledgment frame is sent by the terminal to the first base station and the second base station after receiving the ranging request frame; and
determining location information of the terminal according to the first transceiving moment information.

18. The apparatus according to claim 17, wherein determining location information of the terminal according to the first transceiving moment information further comprises:
determining a first distance between the terminal and the first base station according to the moment associated with the first base station sending the ranging request frame and the moment associated with the first base station receiving the ranging acknowledgment frame;
determining, for each of the at least one second base station, a second distance corresponding to the second base station according to the at least one moment associated with the second base station receiving the ranging acknowledgment frame, the moment associated with the terminal receiving the ranging request frame, and the moment associated with the terminal sending the ranging acknowledgment frame, wherein the second distance is a sum of the first distance and a distance between the terminal and the second base station; and
determining the location information of the terminal according to the first distance and the second distance corresponding to the second base station.

19. The apparatus according to claim 18, wherein determining, for each of the at least one second base station, the second distance corresponding to the second base station further comprises:
determining, for each of the at least one second base station, the second distance corresponding to the second base station according to the at least one moment associated with the at least one second base station receiving the ranging acknowledgment frame, the moment associated with the first base station sending the ranging request frame, the moment associated with the terminal receiving the ranging request frame, and the moment associated with the terminal sending the ranging acknowledgment frame.

20. The apparatus according to claim 18, wherein the first transceiving moment information further comprises the at least one moment associated with the at least one second base station receiving the ranging request frame, and determining, for each of the at least one second base station, the second distance corresponding to the second base station further comprises:
determining, for each of the at least one second base station, the second distance corresponding to the second base station according to a known distance between the second base station and the first base station, the moment associated with the second base station receiving the ranging request frame, the moment associated with the second base station receiving the ranging acknowledgment frame, the moment associated with the terminal receiving the ranging request frame, and the moment associated with the terminal sending the ranging acknowledgment frame.

21-32. (canceled)

33. A non-transitory computer readable medium that stores a set of instructions that is executable by at least one processor of a computer system to cause the computer system to perform a method for determining a position of a terminal communicating with a first base station, the first base station communicating with at least one second base station, the method comprising:
acquiring first transceiving moment information, wherein the first transceiving moment information comprises a moment associated with the first base station sending a ranging request frame, a moment associated with the first base station receiving a ranging acknowledgment frame, a moment associated with the terminal sending the ranging acknowledgment frame, a moment associated with the terminal receiving the ranging request frame, at least one moment associated with the at least one second base station receiving the ranging acknowledgment frame, and at least one moment associated with the at least one second base station receiving the ranging request frame, wherein the ranging request frame is sent by the first base station to the terminal and the at least one second base station and the ranging acknowledgment frame is sent by the terminal to the first base station and the at least one second base station after receiving the ranging request frame; and
determining location information of the terminal according to the first transceiving moment information.

34. The non-transitory computer readable medium according to claim 33, wherein determining the location information of the terminal according to the first transceiving moment information comprises:
determining a first distance between the terminal and the first base station according to the moment associated with the first base station sending the ranging request frame and the moment associated with the first base station receiving the ranging acknowledgment frame;
determining, for each of the at least one second base station, a second distance corresponding to the second base station according to the at least one moment associated with the second base station receiving the ranging acknowledgment frame, the moment associated with the terminal receiving the ranging request frame, and the moment associated with the terminal sending the ranging acknowledgment frame, wherein the second distance is a sum of the first distance and a distance between the terminal and the second base station; and
determining the location information of the terminal according to the first distance and the second distance corresponding to the second base station.

35. The non-transitory computer readable medium according to claim 33, wherein determining, for each of the at least one second base station, the second distance corresponding to the second base station further comprises:
determining, for each of the at least one second base station, the second distance corresponding to the second base station according to the at least one moment associated with the at least one second base station receiving the ranging acknowledgment frame, the moment associated with the first base station sending the ranging request frame, the moment associated with the terminal receiving the ranging request frame, and the moment associated with the terminal sending the ranging acknowledgment frame.

36. The non-transitory computer readable medium according to claim 33, wherein the first transceiving moment information further comprises the at least one moment associated with the at least one second base station receiving the ranging request frame, and determining, for each of the at least one second base station, the second distance corresponding to the second base station further comprises:
determining, for each of the at least one second base station, the second distance corresponding to the second base station according to a known distance between the second base station and the first base station, the moment associated with the second base station receiving the ranging request frame, the moment associated with the second base station receiving the ranging acknowledgment frame, the moment associated with the terminal receiving the ranging request frame, and the moment associated with the terminal sending the ranging acknowledgment frame.

37. The non-transitory computer readable medium according to claim 35, wherein determining the location information of the terminal according to the first distance and the second distance corresponding to the second base station comprises:
determining a spherical surface corresponding to the first base station by using location information of the first base station as the center of circle and using the first distance as the radius;
determining, for each of the at least one second base station, an ellipsoidal surface corresponding to the second base station by using the location information of the first base station and location information of the second base station as focal point of the ellipsoidal surface and using the second distance as a major axis of the ellipsoidal surface; and
determining location information of an intersection point of the spherical surface and the ellipsoidal surface corresponding to the second base station as the location information of the terminal.

38. The non-transitory computer readable medium according to claim 33, wherein determining the location information of the terminal according to the first transceiving moment information further comprises:
determining a first distance between the terminal and the first base station according to the moment associated with the first base station sending the ranging request frame and the moment associated with the first base station receiving the ranging acknowledgment frame;
determining, for each of the at least one second base station, a third distance between the second base station and the terminal according to a known distance between the second base station and the first base station, the first distance of the first base station, the moment associated with the second base station receiving the ranging acknowledgment frame, the moment associated with the second base station receiving the ranging request frame, the moment associated with the terminal receiving the ranging request frame, and the moment associated with the terminal sending the ranging acknowledgment frame; and
determining the location information of the terminal according to the first distance and the third distance corresponding to the second base station.

39. The non-transitory computer readable medium according to claim 38, wherein determining the location information of the terminal according to the first distance and the third distance corresponding to the second base station comprises:
determining a first spherical surface corresponding to the first base station by using location information of the first base station as a center of the first spherical surface and using the first distance as a radius of the first spherical surface;
determining, for each of the at least one second base station, a second spherical surface corresponding to the second base station by using the location information of the second base station as a center of the second spherical surface and using the corresponding third distance as a radius of the second spherical surface; and
determining location information of an intersection point of the first spherical surface and the second spherical surfaces as the location information of the terminal.

40. The non-transitory computer readable medium according to claim 33, wherein
the ranging request frame is sent by the first base station to the terminal and the at least one second base station, simultaneously; and
the ranging acknowledgment frame is sent by the terminal to the first base station and the at least one second base station, simultaneously, after receiving the ranging request frame.

41-48. (canceled)
